(19) United States
(12) Patent Application Publication
(10) Pub. No.: US 2012/0001418 A1
(43) Pub. Date: Jan. 5, 2012

(54) Connector

(76) Inventors: Michel Garcin, Bannans (FR); Sylvain Scotto, Etalans (FR)

(21) Appl. No.: 12/803,699

(22) Filed: Jul. 2, 2010

(51) Int. Cl. F16L 25/06

(52) U.S. Cl. 285/323

(57) ABSTRACT

A connector comprising a receiver, a nut threadably engageable with the receiver, the nut comprising a nut conical surface, a jaw comprising a bead extending radially inward into a jaw bore, the bead for engaging a pipe groove, the jaw having a conical surface for cooperatively engaging the nut conical surface, and a spring disposed between the receiver and the jaw for urging the jaw conical surface into engagement with the nut conical surface and the jaw bead into engagement with the pipe groove.

### FIELD OF THE INVENTION

The invention relates to a connector, and more particularly, to a connector for connecting a tube or stem to another component in a fluid circuit having a multi-piece jaw for engaging a locknut and a pipe groove.

### BACKGROUND OF THE INVENTION

Generally, the connection of piping components is provided by a screwed coupler. This type of fitting requires preparing the pipe, namely, two rings are crimped on the pipe. This part is then blocked between the nut and the screwed locknut maintaining the pipe. The locknut is threaded at the end in order to adapt to the part, see FIG. 1.

This technical solution requires the operator to screw the nut on the locknut. This operation can be long and fastidious because of the bulkiness of different parts in the car preventing the use of any adapted tool.

Representative of the art is U.S. Pat. No. 5,707,086 (1998) which discloses a connector for a tube and a port construction for sealingly and securely receiving the connector. The connector has a male luer comprising a locking hub and a cylindrical tubing port. The cylindrical tubing port receives the free end of the tube. A second piece is provided that envelops the male luer, comprising a elongate cylindrical housing having a interior surface. The male luer and the tube are snugly inserted within the interior surface of the second piece to form a unitary connector. The port receives the connector and has a housing having a first end and a second end and an open interior region defining first and second chambers and a housing axis. The first and second chambers are disposed within the first and second ends of the housing, respectively. A locking knob is movably mounted on the first end of the port apparatus and movable along the housing axis relative to the first end between first and second positions. The knob is rotatable in the second position relative to the first end into a locking engagement with the housing. When the connector is inserted into the first chamber of the port, the user rotates the knob to one side to securely retain the connector. The connector is pressed into sealing contact with an O-ring disposed in the interior region of the first chamber, thereby preventing any leakage around the connector and port. Various alternative tubing connectors are disclosed.

What is needed is a connector having a multi-piece jaw for engaging a locknut and a pipe groove. The present invention meets this need.

### SUMMARY OF THE INVENTION

The primary aspect of the invention is to provide a connector having a multi-piece jaw for engaging a locknut and a pipe groove.

Other aspects of the invention will be pointed out or made obvious by the following description of the invention and the accompanying drawings.

The invention comprises a connector comprising a receiver, a nut threadably engageable with the receiver, the nut comprising a nut conical surface, a jaw comprising a bead extending radially inward into a jaw bore, the bead for engaging a pipe groove, the jaw having a conical surface for cooperatively engaging the nut conical surface, and a spring disposed between the receiver and the jaw for urging the jaw conical surface into engagement with the nut conical surface and the jaw bead into engagement with the pipe groove.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the prior art.

FIG. 2 is a cross-sectional view of the connector.

FIG. 3 is a cross-sectional detail of the pipe.

FIG. 4 is a cross-sectional detail of the connector jaw.

FIG. 5 is a cross-sectional view of the connector with a pipe inserted.

FIG. 6 is a side cross-sectional view of the jaw.

FIG. 7 is a front cross-sectional view of the jaw.

FIG. 8 is a cross-sectional view of the dismounted nut and jaw.

### DETAILED DESCRIPTION OF THE PREFERRED EMBODIMENT

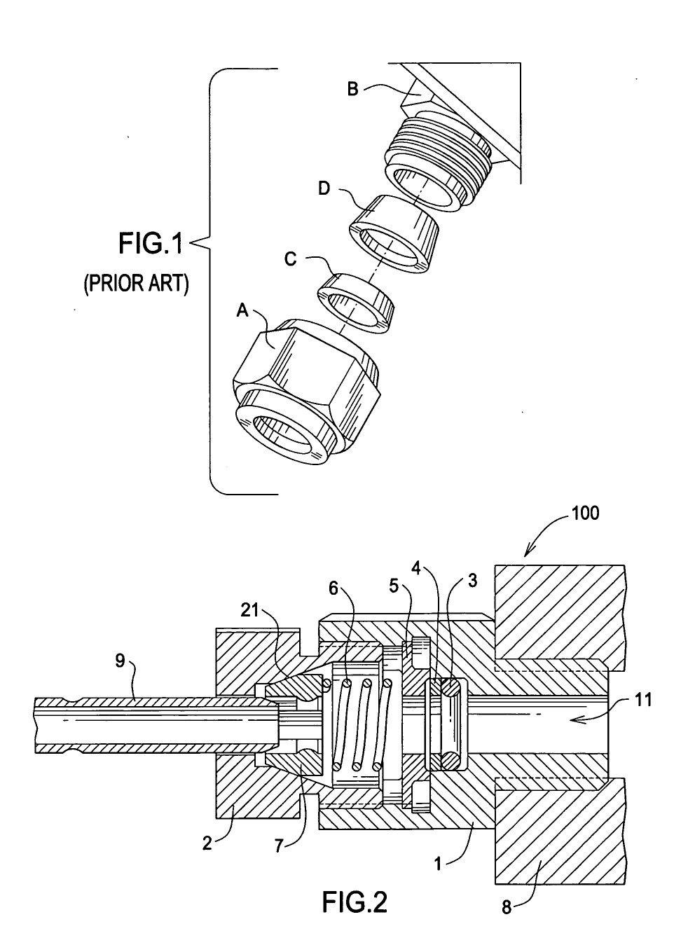

FIG. 1 is a perspective view of the prior art. A nut A screws into a connector body B. A ferrule C grips a pipe that is inserted into the connector. Collar D engages ferrule C to clamp on the pipe.

FIG. 2 is a cross-sectional view of the connector. The connector 100 comprises a receiver 1, locknut, 2, seal 3, seal 4, retainer member 5, spring member 6, and jaw 7. The connector is used to attach a pipe 9 to a mounting portion 8. Mounting portion 8 may comprise any component to which a pipe 9 is connected.

Locknut 2 is threaded into a receiver 1. Receiver 1 in turn is threaded into a mounting portion 8.

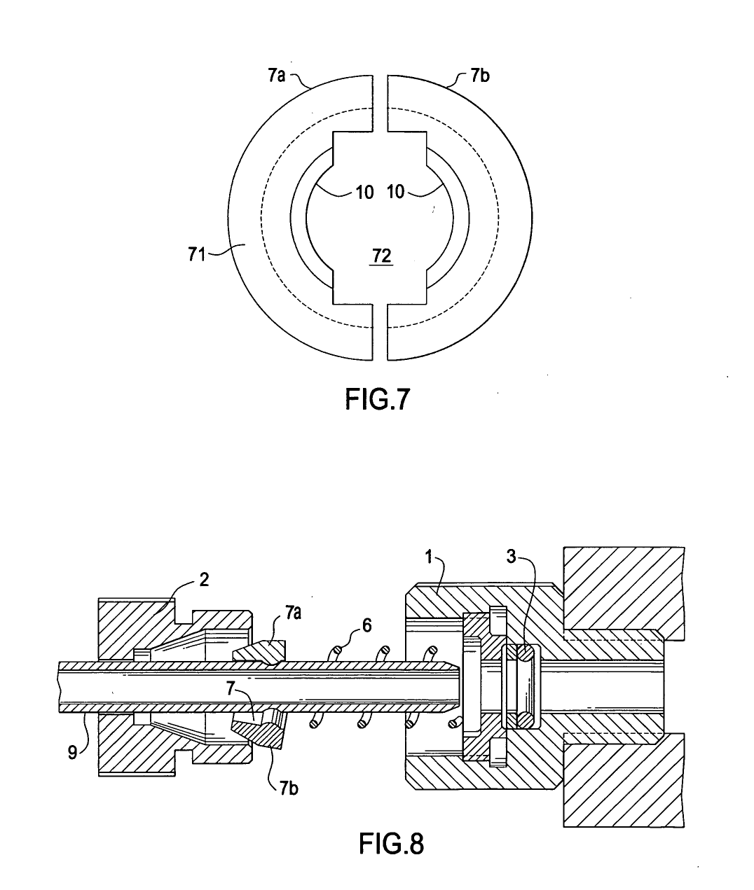

When a pipe 9 is not fully inserted into the connector 100, the two jaws 7 are pressed against the internal conical surface 21 of locknut 2 under the action of the spring 6. Jaws 7 are also in contact with each other when the pipe is not present, see FIG. 6 and FIG. 7. In the preferred embodiment spring member 6 comprises a coil spring oriented coaxially with the pipe 9.

When pipe 9 is fully inserted into locknut 2 the chamfer 91 of the pipe engages the bead 10 of the jaws and moves the jaws 7 apart from the original position. As pipe is inserted jaws 7 move slightly axially which allows them to partially separate, thereby allowing pipe 9 to pass through jaws 7.

Connector 100 further comprises a seal 3 and seal 4. Seal 3 and seal 4 are retained within a bore 11 of receiver 1 by retainer member 5. Retainer member 5 is threaded into receiver 1. Seals 3, 4 provide a pressure boundary between the receiver 1 and pipe 9. The inventive connector may be used with gas or liquid fluids.

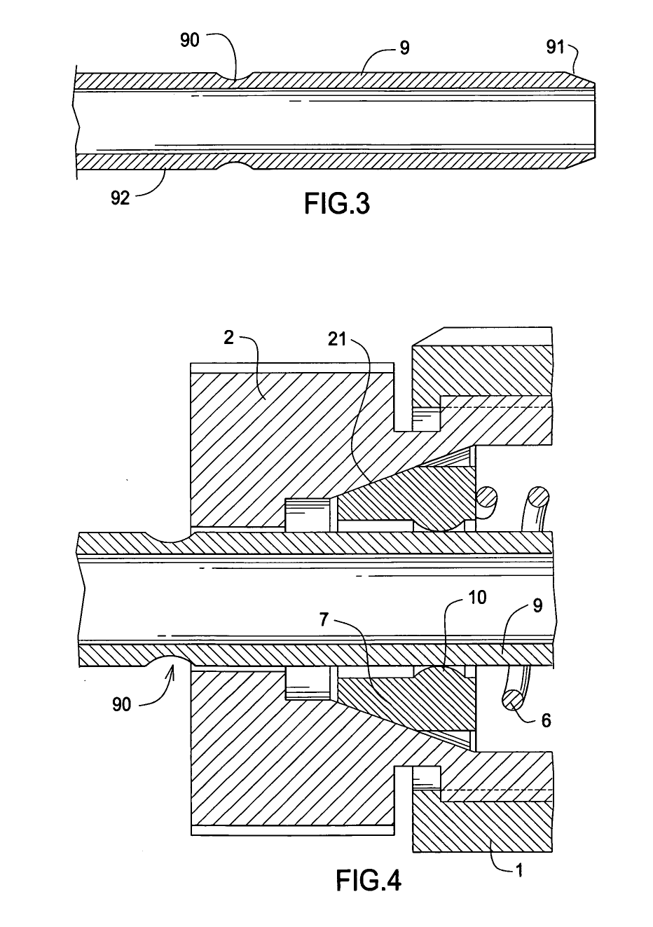

FIG. 3 is a cross-sectional detail of the pipe. Pipe 9 comprises a chamfer 91 at one end and a groove 90 for receiving jaw bead 10. Groove 90 is disposed on an outer surface 92 of pipe 9.

FIG. 4 is a cross-sectional detail of the connector jaw. As pipe 9 is fully inserted bead 10 engages groove 90. After the jaw bead 10 has engaged groove 90 the jaws 7 move axially back into contact with the internal conical surface 21 of the locknut 2, by action of spring 6. As lock nut 2 is further threaded into receiver 1, the engagement of jaw bead 10 with groove 90 will push pipe 9 forward into the receiver, thereby causing a deeper penetration of the pipe into the connector.

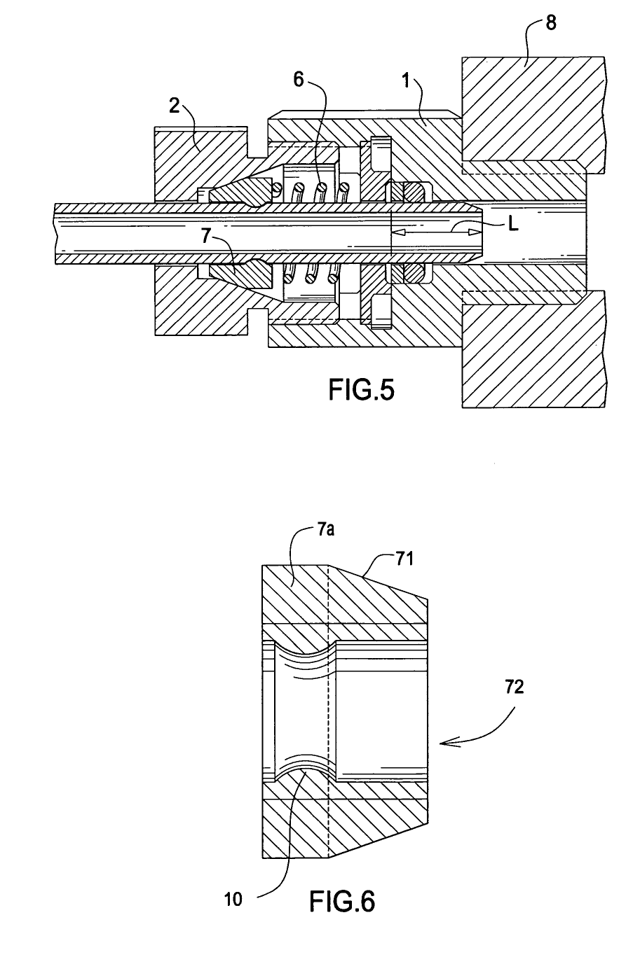

FIG. 5 is a cross-sectional view of the connector with a pipe inserted. Once the groove 90 of the pipe 9 engages bead 10 of the jaws 7, the jaws retract to the original position, namely, back into contact with the internal conical surface 21 of the locknut 2 under the spring force 6. Thus, the pipe is blocked from further axial movement relating to the locknut 2. The pipe 9 cannot be expelled from the connector under a fluid pressure due to the mechanical engagement between the jaw bead 10 and the pipe groove 90.

Insertion of a extended length L of pipe 9 into receiver 1 prevents unintended release of pressure from pipe 9 when nut 2 is loosed and pipe 9 is initially moved. This way, the removal of the pipe is longer than the insertion of the pipe. This ensures a greater security against unexpected disconnection.

FIG. 6 is a side cross-sectional view of the jaw. A conical surface 71 of each jaw portion 7a and 7b engages conical surface 21 of locknut 2. Bead 10 extends radially inward into a bore 72. Bead 10 has an arcuate form in cross-section. Jaw 7 comprises two pieces 7a and 7b.

FIG. 7 is a front cross-sectional view of the jaw. Jaw 7 comprises a first portion 7a and second portion 7b. Each portion is placed opposite the other across a pipe 9. In combination jaw portions 7a and 7b comprise a complete ring which extends around the outer circumference of a pipe 9.

FIG. 8 is a cross-sectional view of the dismounted nut and jaw. The removal of the pipe from the connector simply requires unscrewing of locknut 2. As locknut 2 is unscrewed from receiver 1 this exposes jaw portion 7a and 7b. Jaw portions 7a and 7b are then opened or separated to allow removal from pipe 9. Pipe 9 is withdrawn from seals 3, 4 and from receiver 1.

Although a form of the invention has been described herein, it will be obvious to those skilled in the art that variations may be made in the construction and relation of parts without departing from the spirit and scope of the invention described herein.

We claim:

1. A connector comprising:
a receiver (1);
a nut (2) threadably engageable with the receiver, the nut comprising a nut conical surface (21);
a jaw (7) comprising a bead (10) extending radially inward into a jaw bore, the bead for engaging a pipe groove (90);
the jaw having a conical surface (71) for cooperatively engaging the nut conical surface; and
a member (6) disposed between the receiver and the jaw for urging the jaw conical surface into engagement with the nut conical surface and the jaw bead into engagement with the pipe groove.

2. The connector as in claim 1 further comprising a seal (3) for engaging the pipe.

3. The connector as in claim 2 further comprising a seal retainer (5).

4. The connector as in claim 1, wherein the jaw comprises a first portion (7a) and a second portion (7b).

5. The connector as in claim 1, wherein the spring comprises a coil spring.

6. The connector as in claim 1, wherein the pipe comprises a chamfer (91) at the end engaged with the connector.
